(19) United States
(12) Patent Application Publication
(10) Pub. No.: US 2016/0069482 A1
(43) Pub. Date: Mar. 10, 2016

(54) INFLATABLE HOLE SEALING DEVICE

(71) Applicant: DROR GILADI, GANEY TIKVA (IL)

(72) Inventor: DROR GILADI, GANEY TIKVA (IL)

(21) Appl. No.: 14/847,027

(22) Filed: Sep. 8, 2015

(30) Foreign Application Priority Data
Sep. 10, 2014 (IL) 234582

(51) Int. Cl. F16L 5/02; H02G 3/38

(52) U.S. Cl. CPC F16L 5/027; H02G 3/283; H02G 3/286

(57) ABSTRACT

There is disclosed an inflatable hole sealing device including an inflatable sheet insertable in a hole and suitable to wrap a section of an interconnection means, and an inflation mechanism to introduce an expanding material into the sheet. There is additionally disclosed a kit including the inflatable hole sealing device and an inflator device attachable to the inflation mechanism for administering the expanding material.

### CROSS-REFERENCE TO RELATED APPLICATIONS

This application claims the benefit of priority from Israel Patent Application No. 234582, filed Sep. 10, 2014, the disclosure of which is incorporated herein by reference

### TECHNICAL FIELD

The invention, in some embodiments thereof, relates to methods of sealing openings in walls and floors and, more particularly, but not exclusively, to an inflatable device for sealing the openings in walls and floors.

### BACKGROUND

Some equipment installed in residential, commercial and industrial facilities may be divided into units which work together but are physically distanced one from the other. These units may be physically separated by a barrier such as a wall or a floor through which pipes, ducts, electrical conduits, and/or cables may be passed to mechanically and/or electrically interconnect the units. For convenience hereinafter, the pipes, ducts, electrical conduits, and/or cables may be referred to as “interconnection means”. Examples of these types of equipment may include HVAC (heating, ventilating & air conditioning) equipment, water distribution systems, electrical distribution systems, and communications distribution systems, among others.

In newly-constructed facilities, holes are frequently pre-formed in the walls and floors to allow passing the interconnection means from one side of the wall or floor to the other. In existing facilities, on the other hand, the holes must be formed in the existing walls and floor. Regardless of whether the holes are pre-formed in new walls and floors, or are formed in existing walls and floors, the interconnection means generally do not take up all the space inside the holes and voids remain between the interconnecting means and the perimeter of the hole. Additionally, voids may remain between the different items in the interconnecting means, for example, between cables. These voids may then serve as a conduit for water to leak through from one side of the wall or floor to the other, for dust to pass through, and for insects and pests to crawl through, among other problems which may arise, and which may be further exacerbated if the wall or the floor lead to an exterior of a structure.

Methods are known in the art which attempt to seal these voids. Most rely on the application of a material such as putty, a compound, plaster, or expandable polyurethane foam to fill the spaces. An expandable polyurethane foam which may be applied through a spray is described in http://www.homedepot.com/p/GREAT-STUFF-Big-Gap-Filler-Insulating-Foam-Sealant-16-oz-248314/100029171#specifications. A drawback with these methods is that applying any of the mentioned products to seal all the voids may be difficult, in many cases the interconnecting means possibly interfering with the application. Consequently, the voids may not all be adequately sealed.

### SUMMARY

There is provided, according to an embodiment of the invention, an inflatable hole sealing device including an inflatable sheet insertable in a hole and suitable to wrap a section of an interconnection means, and an inflation mechanism to introduce an expanding material into the sheet.

According to an embodiment of the invention, the inflatable hole sealing device additionally includes a flexible mesh inside the sheet to provide structural rigidity to the sheet when inflated.

According to an embodiment of the invention, the flexible mesh includes a polymeric material.

According to an embodiment of the invention, the flexible mesh includes a metallic material.

According to an embodiment of the invention, the inflatable hole sealing device additionally includes a resistance means to increase a frictional resistance between an outer surface of the sheet and an inner surface of the hole.

According to an embodiment of the invention, the resistance means includes ridges on said outer surface.

According to an embodiment of the invention, the sheet includes a flat shape and is wrappable around the section of the interconnection means.

According to an embodiment of the invention, the sheet includes a sleeve shape and is slippable over the interconnection means.

According to an embodiment of the invention, the sheet includes a through-hole to accommodate the section of the interconnection means.

According to an embodiment of the invention, the inflation means includes a pressure valve.

According to an embodiment of the invention, the inflation means includes a filler tube.

According to an embodiment of the invention, the filler tube includes a cap.

According to an embodiment of the invention, the sheet is deflatable.

According to an embodiment of the invention, the expanding material is any one of polyurethane, putty, a gel, an epoxy, and polyvinyl chloride.

According to an embodiment of the invention, the expanding material is a fluid.

According to an embodiment of the invention, the hole is in a wall or a floor.

There is provided, according to an embodiment of the invention, a kit for sealing a hole in a wall or a floor including an inflatable hole sealing device including an inflatable sheet insertable in the hole and suitable to wrap a section of an interconnection means, and an inflation mechanism to introduce an expanding material into the sheet; and an inflator device attachable to the inflation mechanism for administering the expanding material.

According to an embodiment of the invention, the inflator device includes a pressurized canister.

According to an embodiment of the invention, the inflator device includes a nozzle.

According to an embodiment of the invention, the inflator device includes means to inject the expanding material into the inflation mechanism.

### BRIEF DESCRIPTION OF THE DRAWINGS

Some embodiments of the invention are herein described, by way of example only, with reference to the accompanying drawings. Details shown are for exemplary purposes and serve to provide a discussion of embodiments of the invention. The description and the drawings may be apparent to those skilled in the art how embodiments of the invention may be practiced.

FIG. 1 schematically illustrates a perspective view of an exemplary installation of a room air conditioner unit and an application of an exemplary inflatable hole sealing device, according to an embodiment of the invention;

FIG. 2 schematically illustrates a perspective view of the inflatable hole sealing device including an exemplary flat sheet, according to an embodiment of the invention;

FIG. 3 schematically illustrates a perspective view of the inflatable hole sealing device being wrapped around interconnection means prior to insertion into a hole, according to an embodiment of the invention; and

FIG. 4 schematically illustrates a perspective view of an exemplary inflatable hole sealing device which is shaped as a sleeve, according to an embodiment of the invention.

FIG. 5 depicts the installation of the inflatable hole sealing device of FIG. 1.

FIG. 6 is a perspective view of the inflated state of FIG. 5.

FIG. 7 is a perspective view of the inflated state of FIG. 5, according to another embodiment.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The Applicant has realized that the problems encountered by using known methods for sealing holes may be overcome by an inflatable device which is expandable and may deform to accommodate itself to filling the voids inside the holes. The device may include an inflatable sheet which is fitted to envelop a section of the interconnection means placed inside the hole, and only then inflated to seal the voids in the hole. The sheet may be placed in a deflated state around the interconnecting means prior to insertion into the hole, or alternatively, may first be fitted in its deflated state into the hole and only afterwards are the interconnection means inserted into the hole (through the hole sealer). Once inside the hole and enveloping the interconnection means, the device may be inflated to seal the voids.

According to an embodiment of the invention, the sheet may include a relatively thin, flat shape which may be rolled around the interconnecting means in its deflated state to envelop the interconnecting means. The flat shape may include any geometrical shape suitable to envelop the interconnecting means and to seal the hole when inflated, and which may depend on a size (e.g. diameter of opening, length of hole) and shape (e.g. cylindrical, tapered) of the hole. For example, the flat shape may rectangular, circular, elliptical, triangular, or any other regular or irregular polygonal shape. In some embodiments of the invention, the sheet may include a sleeve which may wrap the interconnection means by slipping the interconnection through the sleeve. The sleeve may be of any shape suitable to allow fitting over the interconnection means and to seal the hole when inflated, and which may depend on the size and shape of the hole. For example, the sleeve may be cylindrically shaped or may be tapered so that one end is larger than the other when inflated, rectangular, and triangular, among other possibilities.

According to an embodiment of the invention, the sheet may be of an elastomeric material or other suitable material which may be inflated and which may be deformed to accommodate itself to the shape of the voids and to seal the spaces. Optionally, the sheet may include a flat flexible sheet, for example a thin plastic sheet, onto which the inflatable material may be placed on one side of the sheet or optionally on both sides. The inflatable material may also be selected to resist abrasion with rough inner surfaces of the hole to prevent puncturing of the sheet. An outer surface of the sheet contacting the inner surfaces of the hole may include ridges or other geometrical patterns which may serve to increase a frictional force between the sheet and the inner surface to substantially prevent dislodgement of the device once inflated inside the hole. Optionally, an inner surface of the sheet in contact with the interconnecting means may include the ridges or other geometrical shapes to increase the frictional force between the sheet and the interconnecting means to substantially prevent dislodgment of the interconnecting means when the device is inflated.

According to an embodiment of the invention, the device may include a mesh inside the sheet to provide structural rigidity when the sheet is inflated inside the hole. The mesh may additionally be flexible to allow ease in manipulating the sheet when fitting around the interconnecting means, whether the sheet is flat-shaped for wrapping or sleeve-shaped. The mesh may be of a natural or synthetic polymeric material including plastic, or alternatively, may be made of metal wire.

According to an embodiment of the invention, the device may be inflated using expanding materials which harden and which may be introduced into the device through an inflation mechanism to cause expansion of the sheet, such as, for example, polyurethane, epoxies, gels, polyvinyl alcohol, among others. Optionally, the expanding materials may include fluids such as a liquid (water) or a non-flammable gas.

According to an embodiment of the invention, the expanding materials may be introduced into the device during manufacturing of the device. The expanding materials may be introduced in fluid form, or may be introduced in a solid form which may easily interact with a fluid, for example, as flakes or a powder. Device inflation may be triggered by introducing a fluid into the device which may chemically react with the expanding material inside the device causing it to expand, and optionally to harden.

According to an embodiment of the invention, the device may be part of a kit which may include an inflator device which may be removably attached to the inflation mechanism in the device for inflating the sheet. The inflator device may include a pressurized container which may include the expanding material and may introduce it into the container under pressure. Alternatively, the inflator device may include an injector for administering the expanding material through the inflation mechanism into the sheet, or may include a spout through which the expanding material may be poured into the inflation mechanism. Alternatively, the inflator device may include a fluid which may react with the expanding material previously introduced into the sheet during manufacture.

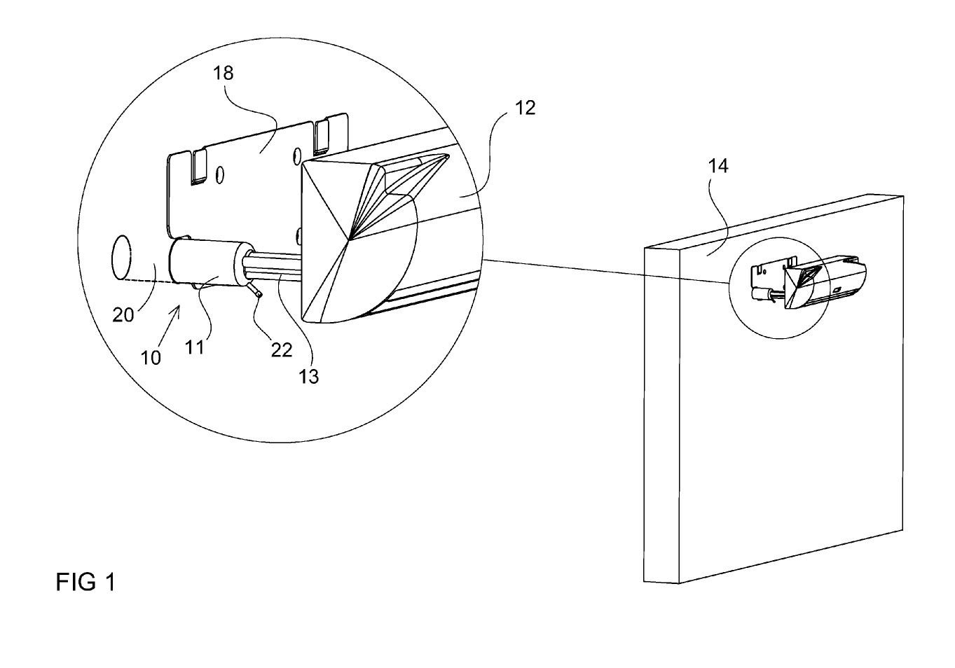

Reference is now made to FIG. 1 which schematically illustrates a perspective view of an exemplary installation of a room air conditioner unit 12 and an application of an exemplary inflatable hole sealing device 10, according to an embodiment of the invention. Inflatable device 10 includes an inflatable sheet 11 and an inflation mechanism 22.

Air conditioner (AC) unit 12 is mounted on a wall 14 and is attached to the wall using an AC unit support 18. Connecting AC unit 12 to an externally located compressor unit (not shown) are interconnecting means 13 which may include electrical cables, control cables, and pipes, among other interconnection items. A hole 20 is made in wall 14 through which interconnecting means 13 pass to connect AC 12 unit with the compressor unit.

According to an embodiment of the invention, inflatable device 10 is fitted over interconnecting means 13 and positioned inside hole 20. Inflated device 10 may be inflated through an inflation mechanism 22 through which an expanding material may be introduced to expand sheet 11 to seal voids in hole 20. Inflation mechanism 22 may include a pressure valve through which expanding materials may be introduced under pressure into sheet 11. Alternatively, inflation mechanism 22 may include a filler tube through which the expanding materials may be introduced into the sheet 11, and may include a sheet (not shown) for closing the filler tube. Inflation mechanism 22 may allow the introduction of the expanding materials into sheet 11 and may additionally prevent removal (emptying) of the expanding material. Alternatively, inflation mechanism 22 may allow removal of the expanding material to allow deflating of sheet 11.

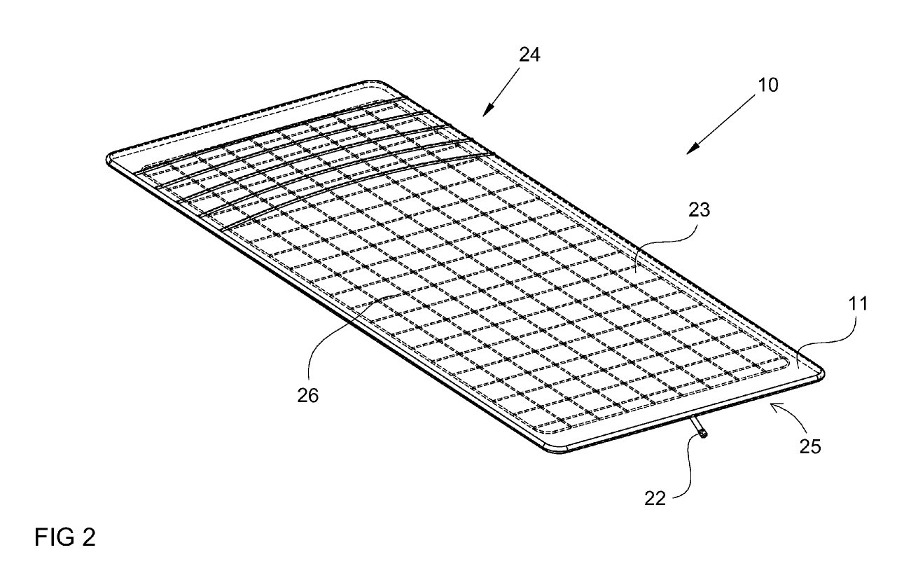

Reference is now also made to FIG. 2 which schematically illustrates a perspective view of inflatable hole sealing device 10 including an exemplary flat sheet 11, according to an embodiment of the invention. Flat sheet 11 may be wrapped around interconnecting means 13 while deflated and prior to insertion into hole 20 to seal voids in the hole. Flat sheet 11 may be inflated once wrapped around interconnecting means 13 and inserted into hole 20.

Flat sheet 11 may be rectangular in shape as shown, although other geometrical shapes are possible. An interior of flat sheet 11 may include a flexible mesh 26 to allow wrapping the sheet over interconnection means 13 and to provide rigidity when the sheet is inflated inside hole 20. An outer surface 23 of flat sheet 11 may include ridges 24 to increase a frictional resistance between the outer surface and an inner surface of hole 20 to prevent inadvertent removal of inflatable device 10 from the hole. Connected at a proximal end 25 of sheet 11 and configured to protrude out of hole 20 is inflation mechanism 22.

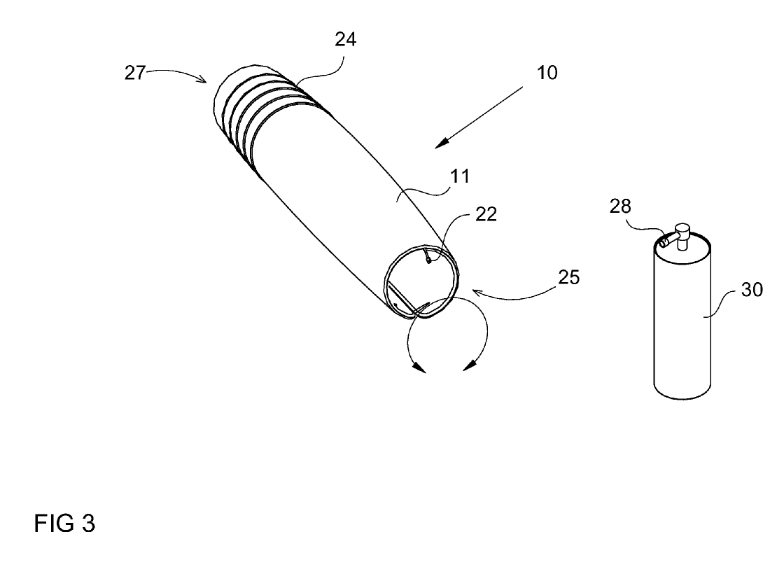

Reference is now also made to FIG. 3 which schematically illustrates a perspective view of inflatable hole sealing device 10 and being wrapped around interconnection means 13 (not shown in the figure) prior to insertion into hole 20, according to an embodiment of the invention. Additionally shown in the figure is an inflator device 30, which may form part of a kit which includes both the inflator device and inflatable device 10, according to an embodiment of the invention.

Sheet 11 is shown deflated and rolled into a cylindrical shape (wrapped around interconnection means 13) including ridges 24 at a distal end 27 of the sheet and inflation mechanism 22 at proximal end 25.

Inflator device 30 may include a pressurized canister holding the expanding material used to inflate sheet 11 once inserted into hole 20. The expanding material may be introduced into sheet 11 through a nozzle 28 in inflator device 30 which may be connected to the inflation valve in inflation mechanism 22.

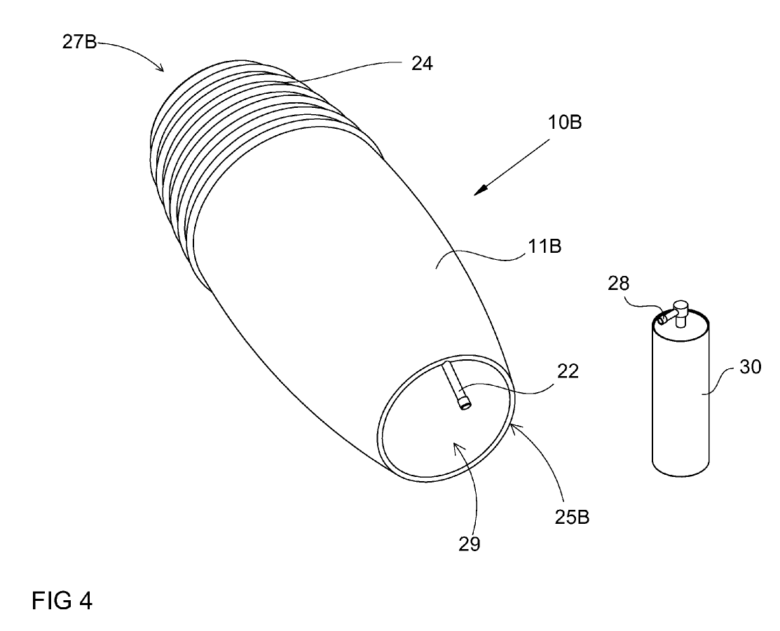

Reference is now made to FIG. 4 which schematically illustrates a perspective view of an exemplary inflatable hole sealing device 10B which is shaped as a sleeve, according to an embodiment of the invention. Additionally shown in the figure is an inflator device 30, which may form part of a kit which includes both the inflator device and inflatable device 10B, according to an embodiment of the invention.

Inflatable device 10B includes a sheet 11B shown deflated and shaped as a cylindrical sleeve having a through-hole 29 through which interconnecting means 13 may be fitted (slipped through the through-hole). Sheet 11B includes ridges 24 at distal end 27B and inflation mechanism 22 at a proximal end 25B.

Sheet 11B may be fitted over interconnecting means 13 prior to being inserted into hole 20 where it may then be inflated. Alternatively, sheet 11 may be first positioned in hole 20 and interconnecting means 13 then slipped through through-hole 29. Following, sheet 11B may be inflated.

Inflator device 30 may include the pressurized canister holding the expanding material used to inflate sheet 11B once inserted into hole 20. The expanding material may be introduced into sheet 11B through nozzle 28 in inflator device 30 which may be connected to the inflation valve in inflation mechanism 22.

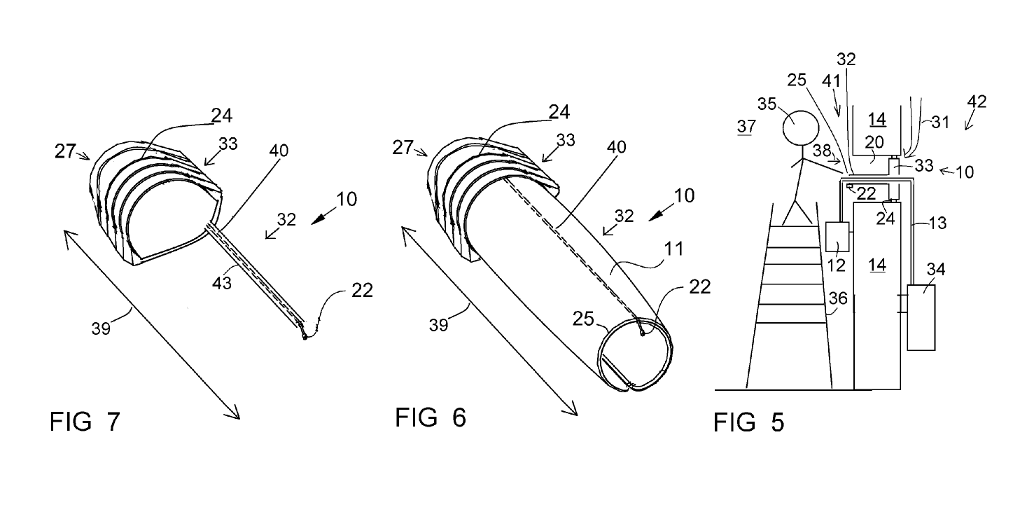

FIG. 5 depicts the installation of the inflatable hole sealing device of FIG. 1.

Interconnecting means 13 extend from in external AC unit 34 through a hole 20 in an external wall 14 into the internal AC unit 12 of FIG. 1.

At the first step, a skilled worker 35, standing on a ladder 36 in the room, presses section 32, being accessible to him, for pressing section 33, being far from him, along the direction of arrow 38.

At the second step, the worker inflates inflatable hole sealing device 10 via inflation mechanism 22 connected at proximal end 25 of inflatable hole sealing device 10, being accessible to the worker.

The rain 31 attempts to enter from the external side 42 of wall 20, and thus only to the external section 33 of inflatable hole sealing device 10 needs to be inflated. Thus only external side 33 requires supply of the expanding material. Ridges 24, disposed only at external section 33 of inflatable hole sealing device 10, may further seal wall 14 to external side 33, for not allowing entrance of rain 31.

Ridges 24 may increase the frictional resistance between the outer surface and an inner surface of hole 20 to prevent inadvertent removal of inflatable device 10 from the hole. Connected at a proximal end 25 of sheet 11 and configured to protrude out of hole 20 is inflation mechanism 22.

FIG. 6 is a perspective view of the inflated state of FIG. 5.

The length 39 of inflatable hole sealing device 10, including the inflatable section 33 and the non-inflatable section 32, is to be sized for the thickest wall. For a thinner wall 14, the non-inflatable section 32 protrudes into room 37, for being cut after drying of the expanding material.

For example, the length of inflatable section 33 is 10 centimeters, and the length of non-inflatable section 32 is 30 centimeters, thus the entire length 39 is 40 centimeters, No matter if the thickness of wall 14 is 10 centimeters or 40 centimeters, the worker pushes inflatable section 33 to the external side 42 of hole 20, even if external side 42 of hole 20 occupies the entire thickness of wall 14.

A thin pipe 40 connects inflation mechanism 22, disposed at proximal end 25, to inflatable section 33, thus the expanding material within pipe 40 dries quite quickly.

Referring again to FIG. 5, the non-inflatable section 32 functions as a rigid extension for allowing the worker to push the inflatable section 33 from the internal side 41 to the external side 42 of hole 20.

Supposing that inflatable sheet refers only to inflatable section 33, the invention may be directed to an inflatable hole sealing device (10), including: an inflatable sheet 33, being suitable to wrap a section of an interconnection means (13), a non-inflatable extension (32), extending from the inflatable sheet (33), being sufficiently rigid for pushing therethrough the inflatable sheet (33) from a first side (41) of a hole (20) of a wall (14) to a second side (42) of the hole (20); and an inflation mechanism (22) including a pipe (40) extending from the inflatable sheet (3), through the non-inflatable extension (32), for introducing, from the first side (41) of the hole (20), an expanding material into the inflatable sheet (33).

FIG. 7 is a perspective view of the inflated state of FIG. 5, according to another embodiment.

The non-inflatable section 32 may constitute a rigid rod 43. Pipe 40 may be threaded in non-inflatable section 32, as depicted in FIGS. 6 and 7, or may be outside it.

Thus, the invention is directed to an inflatable hole sealing device (10), including:

an inflatable sheet (33), being suitable to wrap a section of an interconnection means (13),

a non-inflatable extension (32), extending from the inflatable sheet (33), being sufficiently rigid for pushing therethrough the inflatable sheet (33) from a first side (41) of a hole (20) to a second side (42) of the hole (20); and

an inflation mechanism (22) including a pipe (40) extending from the inflatable sheet (33), for introducing, from the first side (41) of the hole (20), an expanding material into the inflatable sheet (33).

The pipe (40) may extend through the non-inflatable extension (32).

The inflatable hole sealing device (10) according to claim 1 may further include:

at least one ridge (24) disposed on the inflatable sheet (33), for sealing the inflatable sheet (33) to the hole (20) upon inflating the inflatable sheet (33).

The inflatable hole sealing device (10) according to claim 1 may further include:

a flexible mesh inside the sheet to provide structural rigidity to the sheet when inflated.

The flexible mesh may include a member selected from a group consisting of: a polymeric material, a metallic material.

The inflatable hole sealing device (10) according to claim 1 may further include:

a resistance means to increase a frictional resistance between an outer surface of the sheet and an inner surface of the hole.

The resistance means may include ridges on the outer surface.

The sheet may have a flat shape and may be wrappable around the section of the interconnection means.

The sheet may have a sleeve shape and may be slippable over the interconnection means.

The sheet may include a through-hole to accommodate the section of the interconnection means.

The inflation means may include a pressure valve.

The inflation means may include a filler tube.

In the figures and/or description herein, the following reference numerals have been mentioned:

| Part Identification | Reference No. |
|---|---|
| Inflatable Hole Sealing Device | 10 |
| Inflatable Hole Sealing Device | 10B |
| Flat Sheet | 11 |
| Sleeve Sheet | 11B |
| AC Unit | 12 |
| Interconnecting Means | 13 |
| Wall | 14 |
| AC Unit Support | 18 |
| Hole | 20 |
| Inflation Mechanism | 22 |
| Outer Surface | 23 |
| Ridges | 24 |
| Proximal End | 25 |
| Proximal End | 25B |
| Flexible Mesh | 26 |
| Distal End | 27 |
| Distal End | 27B |
| Nozzle | 28 |
| Through-hole | 29 |
| Inflator Device | 30 |
| Rain | 31 |
| Non-inflatable section | 32 |
| Inflatable section | 33 |
| External AC unit | 34 |
| Skilled worker | 35 |
| Ladder | 36 |
| Room | 37 |
| Arrow | 38 |
| Length | 39 |
| Pipe | 40 |
| Internal side of the hole in the wall | 41 |
| External side of the hole in the wall | 42 |
| Rod | 43 |

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An inflatable hole sealing device, comprising:
an inflatable sheet, being suitable to wrap a section of an interconnection means,
a non-inflatable extension, extending from said inflatable sheet, being sufficiently rigid for pushing therethrough said inflatable sheet from a first side of a hole to a second side of said hole; and
an inflation mechanism comprising a pipe extending from said inflatable sheet, for introducing, from said first side of said hole, an expanding material into said inflatable sheet.

2. An inflatable hole sealing device according to claim 1, wherein said pipe extends through said non-inflatable extension.

3. An inflatable hole sealing device according to claim 1, further comprising:
at least one ridge disposed on said inflatable sheet, for sealing said inflatable sheet to said hole upon inflating said inflatable sheet.

4. An inflatable hole sealing device according to claim 1 further comprising a flexible mesh inside said sheet to provide structural rigidity to said sheet when inflated.

5. An inflatable hole sealing device according to claim 4 wherein said flexible mesh comprises a member selected from a group consisting of: a polymeric material, a metallic material.

6. An inflatable hole sealing device according to claim 1 further comprising a resistance means to increase a frictional resistance between an outer surface of said sheet and an inner surface of the hole.

7. An inflatable hole sealing device according to claim 6 wherein said resistance means comprises ridges on said outer surface.

8. An inflatable hole sealing device according to claim 1 wherein said sheet comprises a flat shape and is wrappable around said section of said interconnection means.

9. An inflatable hole sealing device according to claim 1 wherein said sheet comprises a sleeve shape and is slippable over said interconnection means.

10. An inflatable hole sealing device according to claim 1 wherein said sheet comprises a through-hole to accommodate said section of said interconnection means.

11. An inflatable hole sealing device according to claim 1 wherein said inflation means comprises a pressure valve.

12. An inflatable hole sealing device according to claim 1 wherein said inflation means comprises a filler tube.

13. An inflatable hole sealing device according to claim 1 wherein said filler tube comprises a cap.

14. An inflatable hole sealing device according to claim 1 wherein said sheet is deflatable.

15. An inflatable hole sealing device according to claim 1 wherein said expanding material is any one of polyurethane, a putty, a gel, an epoxy, and polyvinyl chloride.

16. An inflatable hole sealing device according to claim 1 wherein said expanding material is a fluid.

17. An inflatable hole sealing device according to claim 1 wherein said hole is in a wall or a floor.

18. An inflatable hole sealing device according to claim 1, further comprising:
an inflator device attachable to said inflation mechanism for administering said expanding material.

19. An inflatable hole sealing device according to claim 18 wherein said inflator device comprises a pressurized canister.

20. An inflatable hole sealing device according to claim 18 wherein said inflator device comprises a nozzle.

21. An inflatable hole sealing device according to claim 18 wherein said inflator device comprises means to inject said expanding material into said inflation mechanism.
